(19) United States
(12) Patent Application Publication
(10) Pub. No.: US 2026/0274142 A1
(43) Pub. Date: Sep. 17, 2026

(54) SOLAR TABLE MOBILE TRANSPORT WITH SIDESHIFT

(71) Applicant: Terabase Energy, Inc., Berkeley, CA (US)

(72) Inventors: Adam Hansel, Davis, CA (US); Tyler Grushkowitz, Corvallis, OR (US); Brian Coleman, Portland, OR (US); Soren Jensen, Corte Madera, CA (US)

(73) Assignee: Terabase Energy, Inc., Berkeley, CA (US)

(21) Appl. No.: 19/676,342

(22) Filed: May 13, 2026

Related U.S. Application Data
(63) Continuation of application No. 18/214,245, filed on Jun. 26, 2023, now Pat. No. 12,662,038.

(51) Int. Cl. B60P 1/00; B25J 5/00; B60P 3/00

(52) U.S. Cl. CPC B60P 1/00; B25J 5/007; B60P 3/00

(57) ABSTRACT

A solar table mobile transport with sideshift capability is described that moves a solar table to a point of installation. The solar table mobile transport comprises multiple motors that allow movement within a three-dimensional coordinate system as well as provide angular controls of pitch, yaw and roll. Extended horizontal movement of the solar table is provided by a sideshift element that extends the solar table beyond an edge of a transport component of the solar table mobile transport.

### CROSS-REFERENCE TO RELATED APPLICATIONS

This application is a continuation of U.S. Patent Application No. 18/214,245 (Docket No. 20179-2569US), filed on June 26, 2023, entitled “SOLAR TABLE MOBILE TRANSPORT WITH SIDESHIFT”, and listing Adam Hansel, Tyler Grushkowitz, Brian Coleman, and Soren Jensen as inventors. The aforementioned patent document is incorporated by reference herein in its entirety.

### TECHNICAL FIELD

The present disclosure relates generally to a motorized solar table transport with horizontal sideshift capability that is used in the construction of large-scale solar systems. More particularly, the present disclosure relates to a motorized solar table transport with horizontal sideshift capability that moves a solar table from a solar table assembly factory to an installation point and provides extended horizontal, vertical and angular movement of a solar table for alignment to a specific installation site within the large-scale solar system.

### BACKGROUND

The importance of solar power systems is well understood by one of skill in the art. Government agencies and companies are scaling the size and number of solar solutions within their energy infrastructure. This transition from traditional fossil fuel energy systems to solar energy solutions presents several challenges. One challenge is cost-effective management of the construction process and the ability to efficiently move components around the site during the construction process.

Large-scale solar panel systems typically include thousands of solar panels that are located across a multi-acre terrain and that are electrically coupled to provide a source of energy. These large-scale systems are oftentimes located in remote areas and require a significant investment in materials, resources and labor in their installation and design. The sourcing and delivery of materials and resources for these installations can be problematic and inconsistent. A further complication is the reliable and safe movement of these materials and resources across large areas of the construction site as well as maintaining consistent installation processes at each point of installation within the site. These issues further contribute to an increase in the cost and complexity of what is already a very cost-sensitive process.

FIG. 1 illustrates a typical prior-art installation process for solar systems. This prior-art installation process is implemented such that all mounting equipment for each solar panel is individually assembled and installed at its location within the larger system. The cost-effectiveness of this approach works fine within smaller solar deployments but struggles to cost-effectively scale to large solar systems as described below.

This traditional deployment 101 relies on materials being delivered to a deployment site via an access road. The materials are then processed and staged at the deployment site by a crew. A small portion of this delivered material is then moved by heavy equipment to a specific location where a solar panel and mounting equipment are assembled and installed at that location 102. The step is then repeated for an adjacent location 103 where materials are subsequently delivered, assembled and installed for a neighboring solar table within the system. While this approach may be effectively deployed in the installation of smaller solar systems, it becomes cost-prohibitive as the size of the system increases.

What is needed are systems, devices and methods that reduce the complexity and cost of the installation of large-scale solar panel systems.

### BRIEF DESCRIPTION OF THE DRAWINGS

References will be made to embodiments of the invention, examples of which may be illustrated in the accompanying figures. These figures are intended to be illustrative, not limiting. Although the invention is generally described in the context of these embodiments, it should be understood that the description is not intended to limit the scope of the invention to these particular embodiments. Items in the figures may be not to scale.

FIGURE(“FIG.”) 1 shows a prior art assembly and installation process of large-scale solar panel systems.

FIG. 2 is a diagram showing a centralized assembly and installation of a solar system including mobile transport of solar tables in accordance with various embodiments of the invention.

FIG. 3 is an exemplary sequence of diagrams illustrating an installation of a solar table within a solar system using a mobile transport according to various embodiments of the invention.

FIG. 4 is a side view of a solar table mobile transport with sideshift capability according to various embodiments of the invention.

FIG. 5 is a front view of a first solar table mobile transport with sideshift capability in accordance with various embodiments of the present invention.

FIG. 6 is a front view of a second solar table mobile transport with sideshift capability in accordance with various embodiments of the present invention.

FIG. 7 is a front view of a solar table mobile transport with sideshift capability and at least one stabilizer according to various embodiments of the invention.

FIG. 8 is a front view of a solar table mobile transport with sideshift capability and at least one counterweight according to various embodiments of the invention.

### DETAILED DESCRIPTION OF EMBODIMENTS

In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be implemented in a variety of ways, such as a process, an apparatus, a system, a device, or a method.

Components, or features, shown in diagrams are illustrative of exemplary embodiments of the invention and are meant to avoid obscuring the invention. It shall also be understood that throughout this discussion that components may be described as separate functional units, which may comprise sub-units, but those skilled in the art will recognize that various components, or portions thereof, may be divided into separate components or may be integrated together, including integrated within a single system or component. It should be noted that functions or operations discussed herein may be implemented as components. Components may be implemented in a variety of mechanical structures supporting corresponding functionalities of the solar table mobile transport with sideshift capability.

Furthermore, connectivity between components or systems within the figures are not intended to be limited to direct connections. Also, components may be integrated together or be discrete prior to construction of a solar panel mobile transport with sideshift capability.

Reference in the specification to “one embodiment,” “preferred embodiment,” “an embodiment,” or “embodiments” means that a particular feature, structure, characteristic, or function described in connection with the embodiment is included in at least one embodiment of the invention and may be in more than one embodiment. Also, the appearances of the above-noted phrases in various places in the specification are not necessarily all referring to the same embodiment or embodiments.

The use of certain terms in various places in the specification is for illustration and should not be construed as limiting. A component, function, or structure is not limited to a single component, function, or structure; usage of these terms may refer to a grouping of related components, functions, or structures, which may be integrated and/or discrete.

Further, it shall be noted that: (1) certain components or functionals may be optional; (2) components or functions may not be limited to the specific description set forth herein; (3) certain components or functions may be assembled/combined differently across different solar table mobile transports; and (4) certain functions may be performed concurrently or in sequence.

Furthermore, it shall be noted that many embodiments described herein are given in the context of the assembly and installation of large numbers of solar tables within a system, but one skilled in the art shall recognize that the teachings of the present disclosure may apply to other large and complex construction sites in which resources and personnel are difficult to manage and accurately predict. Additionally, embodiments of a solar table mobile transport may be implemented in smaller construction sites.

In this document, “large-scale solar system” refers to a solar system having 1000 or more solar panels. The word “resources” refers to material, parts, components, equipment or any other items used to construct a solar table and/or solar system. The word “personnel” refers to any laborer, worker, designer or individual employed to construct or install a solar table or solar system. The term “solar table” refers to a structural assembly comprising a torque tube and/or purlins with module rails. Some types of solar tables may have supplemental structure that allows it to connect to foundations/piles while other types do not have this supplemental structure. A solar table may have (but is not required) solar panels and/or electrical harnesses. The term “solar table mobile transport” (hereinafter, “mobile transport”) describes a vehicle used to move a solar table to an installation site and facilitate an installation process of the solar table. A mobile transport may be driven by personnel, controlled by remote control or move autonomously within at least a portion of a solar system construction site. The term “transport component” refers to a lower portion of the mobile transport that provides movement and includes wheels (or similar features such as a tractor assembly or robotic system), steering mechanism (autonomous or personnel driven) and braking mechanism. The term “solar table alignment and support component” (hereinafter referred to as a “STAS component”) is a structure that couples to the transport component and secures a solar table above the transport component. The STAS component provides alignment capability such that a torque tube and/or solar table may be moved in vertical, horizontal and angular motions. In certain embodiments, the STAS component comprises a sideshift structure that provides horizontal movement of the solar table beyond a plane defined by an outer edge of the transport component. In certain embodiments, the sideshift structure may also comprise a motor that provides horizontal movement of the solar table. The sideshift structure may be located anywhere within the STAS component including near the top or near the bottom of the STAS component. The term “motor” is defined as a structural device that produces motion of a solar table, this motion may be unidirectional or multidirectional. Examples of some motors may include elements such as actuators, tracks, etc. that help in producing motion of structures within the mobile transport or the solar table.

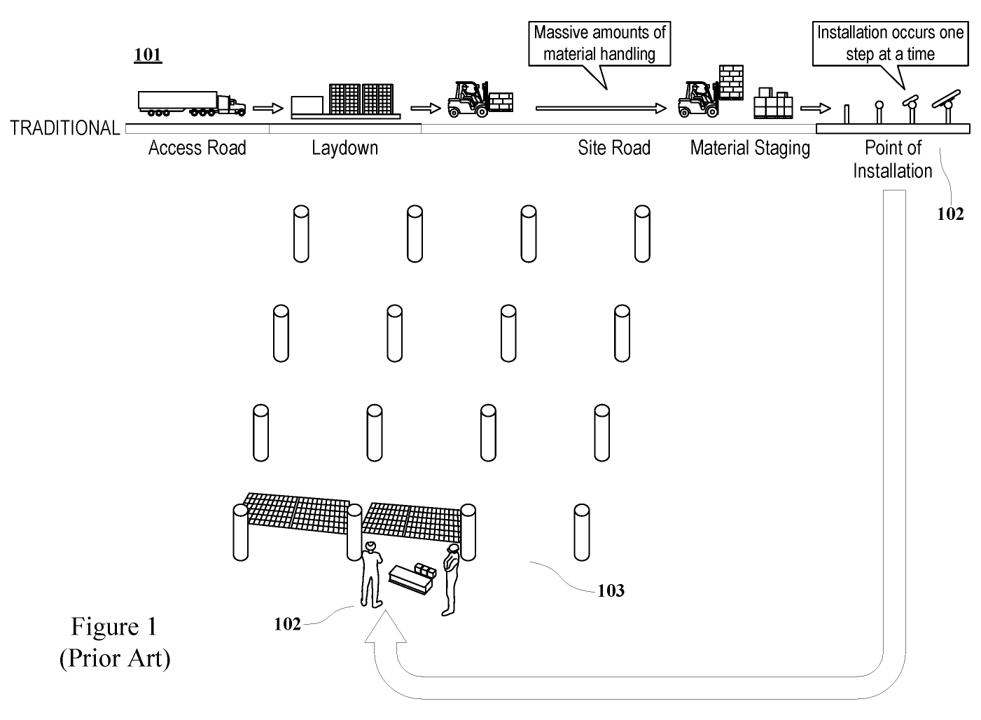

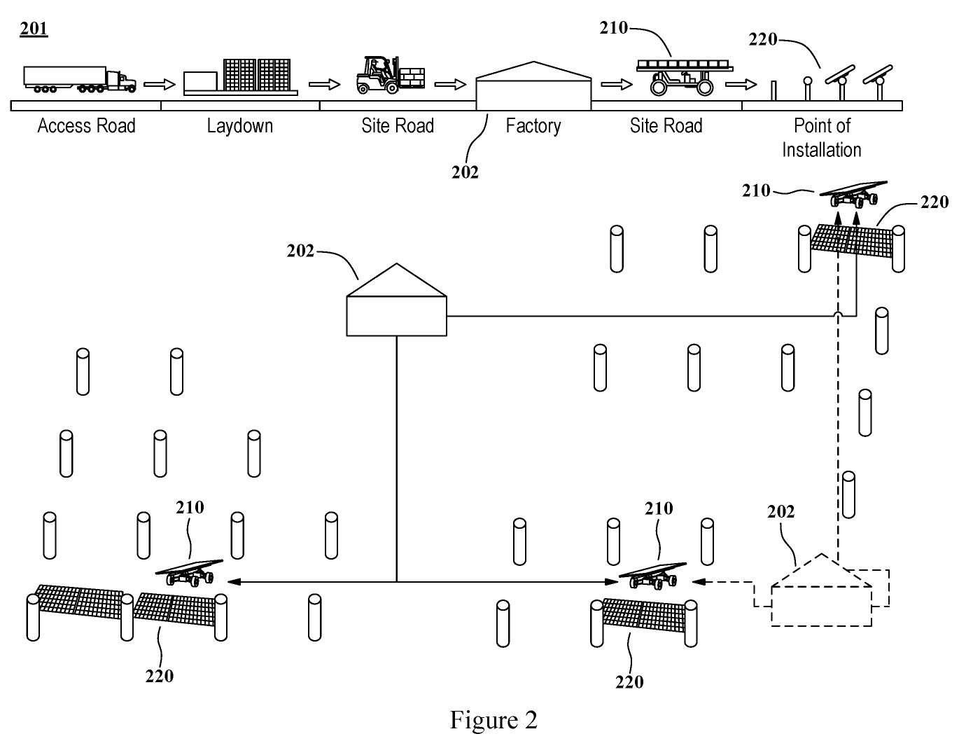

FIG. 2 provides an overview of a centralized solar table assembly and installation for large-scale solar systems according to various embodiments of the invention. Embodiments of the invention transition the prior art approach of assembly and installation at single location sites to a centralized and coordinated assembly factory that allows a more cost-effective and dynamic process of constructing large-scale solar systems. This centralized assembly of solar system components, such as solar tables, necessitates a more robust transport vehicle to move the pre-assembled components to the installation site. Additionally, the installation of these pre-assembled components may require functionality to support the alignment and integration of these components into the system. This alignment of a solar table secured on a mobile transport to a particular installation site is aided by horizontal motion facilitated by a sideshift structure and vertical motion via a STAS component.

Resources are brought to construction site 201 for a large-scale solar systems and initially processed. These resources are delivered to one or more assembly factories 202 where a coordinated and centralized solar table assembly process is performed. In certain embodiments, a construction site may have multiple centralized factories 202. As shown in FIG. 2, there are two centralized factories 202 strategically located at the site. The location and number of centralized factories 202 may depend on several parameters including the size of the site, the terrain of the site, the design of the site and other variables that relate to the construction of the large-scale solar system.

Assembled solar tables and equipment are moved from factory 202 to an installation site 220 via motorized vehicles 210 such as a mobile transport with sideshift capability. In certain embodiments, the mobile transports are specifically designed to transport solar tables along a site road to the point of installation 220. As previously mentioned, the mobile transports 210 may be driven by personnel, may be controlled by remote control or autonomously driven by a computer system. The time and/or sequence in which solar tables are delivered to points of installation 220 may depend on a variety of factors that may be analyzed to configure a preferred schedule.

Delivery of an assembled solar table to an installation site requires an alignment process to securing points at the installation site. Because an assembled solar table is oftentimes large and heavy, this alignment process may be difficult and require significant effort by personnel to properly align both ends of a solar table to receptors, piles or other coupling elements at the installation site. Embodiments of the solar table mobile transport with sideshift capability allows motorized alignment of the solar table while it is still secured to the mobile transport. The sideshift capability also allows a less precise positioning of the mobile transport at the installation site due to the sideshift capability to provide extended horizontal movement of the solar table. As a result, the mobile transport is parked proximate to the installation site but does not require precise parking to initiate an alignment and installation process.

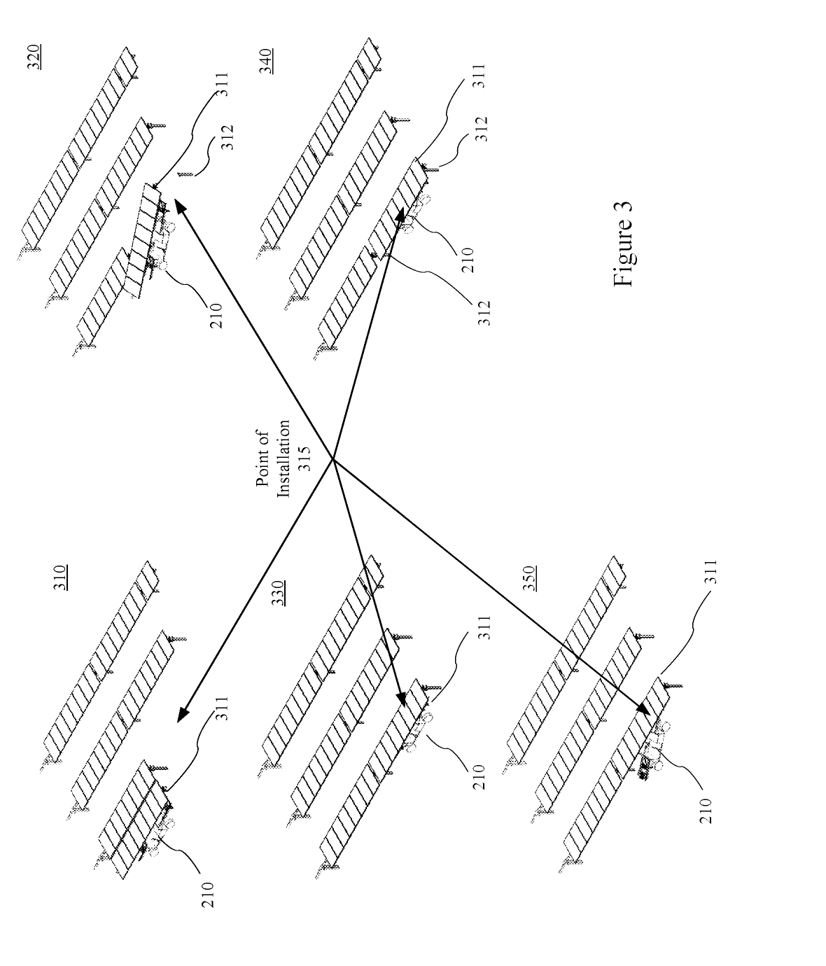

FIG. 3 illustrates a sequence of installation steps of a solar table at an installation site using a solar panel mobile transport with sideshift capability according to various embodiments of the invention. As shown in 310, a mobile transport 210 supporting a solar table 311 approaches a point of installation 315. The solar table 311 is secured to the mobile transport 210 by a solar table attachment component that securely holds the solar table above the mobile transport 210. In certain embodiments, the solar table 311 is assembled and secured to the attachment component at a centralized assembly factory and subsequently driven to the point of installation 315.

As shown in 320, the mobile transport 210 approaches the point of installation 315 in preparation for installation within the solar system. The point of installation 315 comprises structures used to secure the solar table 311 within the system. For example, a solar table 312 may be secured to a previously installed table whereby a torque tube in the solar table 311 is inserted into a previously installed table. The previously installed table may be secured to a pile 312 where threaded fasteners/rivets connect its bearing housing assembly/brackets to the pile 312. As shown in 330, the mobile transport 210 aligns the solar table 311 at the installation point 315 for subsequent integration into solar system. This alignment process will be discussed in more detail below and includes alignment along a three-dimensional coordinate system as well as angular control of yaw, pitch and roll. As previously stated, sideshift capability on the mobile transport 210 allows for this alignment when the mobile transport 210 is located proximate to the installation site and does not require precise parking of the mobile transport relative to the location site.

As shown in 340, the solar table is secured within the solar system after alignment is completed. This securitization process includes attached the solar table 210 to piles 312 that lock the solar table in line with adjacent solar tables. One skilled in the art will recognize that other processes may be employed to securely lock a solar table 311 within the system and may use other components that replace or supplement the piles 312.

As shown in 350, mobile transport 210 detaches from the solar table 311 after an alignment process has occurred using horizontal, vertical and angular control as needed. The STAS component lowers after the solar table 311 is secured within the system so that the mobile transport 210 may leave the point of installation 315.

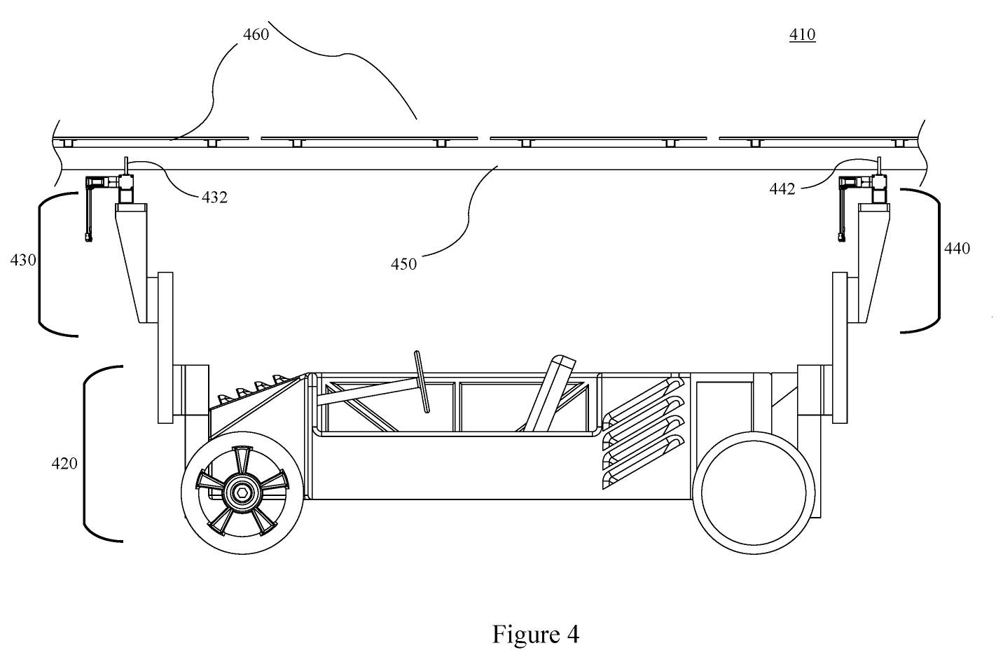

FIG. 4 illustrates a side view of a mobile transport with sideshift capability in accordance with various embodiments of the invention. This mobile transport 410 comprises a first STAS component 430, a second STAS component 440 and a transport component 420 that support a robust vehicle that can securely move solar tables to an installation point and perform alignment and integration of the solar table into the solar system. In this example, the first STAS component 430 and the second STAS component 440 are coupled to a torque tube 450 and provide both vertical and horizontal movement of the solar table having multiple solar panels 460. In certain embodiments, the first and second STAS components 430, 440 comprise multiple motors that cause horizontal and vertical movement of the solar table. The horizontal and vertical movement caused by the first STAS component 430 and the horizontal and vertical movement caused by the second STAS component 440 operate at least partially independent of each other to enable angular control of the torque tube and/or solar table. This angular control (as well as the horizontal and vertical movements) allows a dynamic alignment process of the torque tube 450 within the installation site. According to various embodiments, the horizontal, vertical and angular motion of the torque tube 450 may be motorized or controlled by personnel by applying force to the torque tube 450 or other component(s) on the solar table.

The transport component 420 comprises a vehicular segment that can move throughout a solar system construction site under the control of a driving system. Examples of the vehicular segment include a wheel system, tractor system and/or robotic movement system that moves a solar table from a factory to an installation point. The transport component 420 comprises a driving system that effectively controls the movement of the mobile transport as it carries a solar table from a centralized, factory to an installation site. Examples of a driving system include systems that are controlled by an in-vehicle driver, a remote control being used by personnel or an autonomous driving system. If an autonomous driving system is employed, the transport component 420 comprises autonomous driving capabilities which include both a vehicle location element (such as a GPS location, autonomous sensor and image processing, and/or virtual construction site map including roads between factories and installation sites). One skilled in the art will recognize that the transport component 420 may be modified and/or supplemented with a variety of structural and functional elements to further assist in the transportation of solar tables within a solar system construction site.

The STAS components 430, 440 may be located above and coupled to the transport component 420. The STAS components 430, 440 may also be an extension to transport component 420 at a variety of angles and across one or more portions of the STAS components 430, 440. The STAS components 430, 440 comprise a plurality of attaching elements that securely attach to a solar table. In one example, the attaching elements are end effectors that securely hold a torque tube 450 to allow movement and alignment processes. As previously described, the STAS components 430, 440 also includes independent motors that position and align a solar table within a three-dimensional space as well as control angular movement to facilitate proper integration into a system. As will be described in more detail below, these motors can provide alignment of heavy structures, such as solar tables, with personnel controlling the motors or autonomous control where alignment movement is driven by sensors.

Solar table securing clamps, such as end effectors 432 and 442, may be positioned anywhere on the STAS components 430, 440 respectively to securely hold a variety of different shapes and types of solar tables. In one embodiment, the solar table securing clamps are positioned along an axis to allow secure attachment to a torque tube 450 of a solar table. This torque tube 450 may have other components, such as solar panels 460, attached to it.

One skilled in the art will recognize that the attachment component may be modified and/or supplemented with a variety of structural and function elements to further assist in the attachment process to a solar table or the alignment/installation process of the solar table within the solar system. These attachment components may couple to any structural part of the solar table in accordance with different embodiments of the invention.

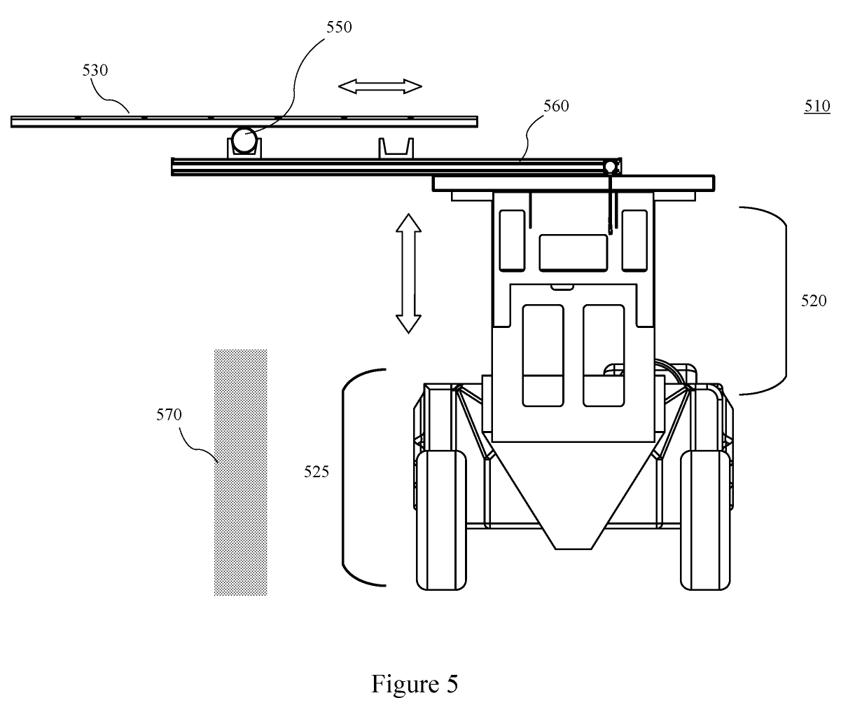

FIG. 5 illustrates a front view of a mobile transport with sideshift capability in accordance with various embodiments of the invention. The mobile transport 510 comprises a transport component 525 that provides movement to the mobile transport. The mobile transport 510 also comprises a first STAS component 520 and a second STAS component that is not shown and positioned behind the first STAS component 520. The first STAS component 520 comprises a sideshift element 560 that provides horizontal motion of a solar table 530. The sideshift element 560 is coupled to the solar table at the torque tube 550. In this particular example, the sideshift element 560 is shown as a rail having a motorized track that moves the solar table 530 along a horizontal plane. One skilled in the art will recognize that the sideshift element may be realized in a variety of different structures and may be motorized or manually controlled by personnel.

In this example, mobile transport 510 is parked proximate to a pile 570 to which the solar table 530/torque tube 550 is to be aligned and secured. In many instances, the torque tube 550 is secured at two or more securing elements (e.g., between two adjacent solar tables, between two piles, a combination thereof, or other types of securing elements). The sideshift capability of the mobile transport 510 allows it to be parked proximate to these securing elements instead of between the elements. In particular, the sideshift element 560 provides extended horizontal movement of the solar table 530 to facilitate alignment without the mobile transport 510 being positioned in between the securing elements.

As previously described, the first STAS component 520 (along with the second STAS component) facilitates horizontal, vertical and angular control such that the heavy solar table 530 is properly positioned relative to the securing elements to allow appropriate installation at the site.

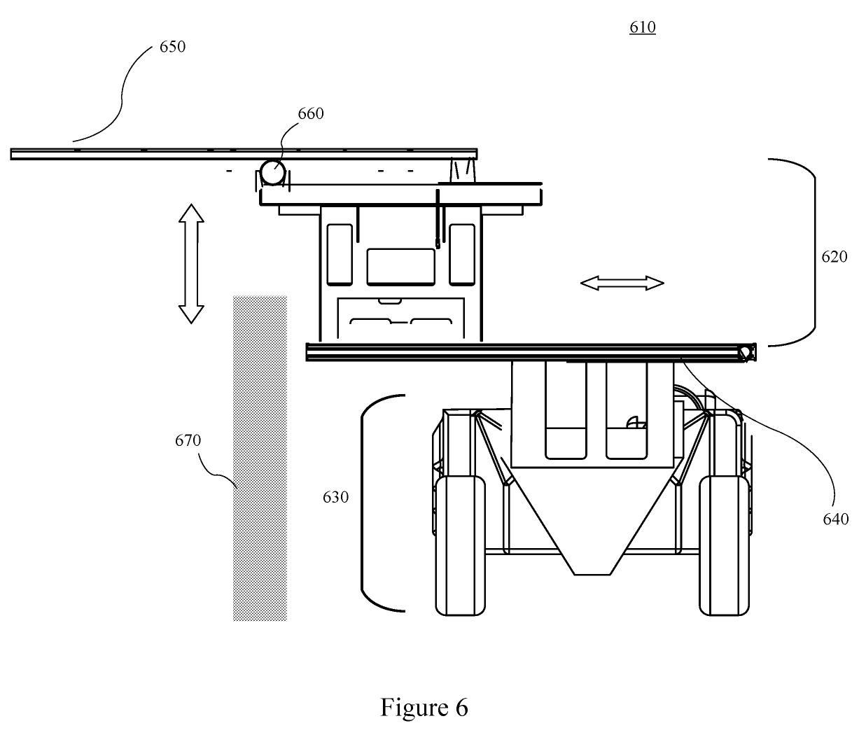

FIG. 6 is a front view of another example of a mobile transport with sideshift capability in accordance with various embodiments of the invention. In this particular example, the sideshift element is positioned near the bottom of the STAS components.

Referring to this figure, the mobile transport 610 comprises a transport component 630 and a first STAS component 620 (the second STAS component is not shown but positioned behind the first STAS component). The sideshift element 640 is positioned near the bottom of the first STAS component 620. A torque tube 660 on a solar table 650 is coupled to the first STAS 620 so that horizontal, vertical and angular motion may be performed during an alignment process. In this embodiment, the sideshift element 640 provides extended horizontal movement of the torque tube 660/solar table 650. As was the case in the first example, the extended horizontal movement provided by the sideshift element 640 allows for less precise positioning of the mobile transport 610 relative to the installation site. Accordingly, the mobile transport 610 should be parked sufficiently close to the pile 670 so that the extended horizontal movement allows horizontal alignment between the torque tube 660 and the pile 670.

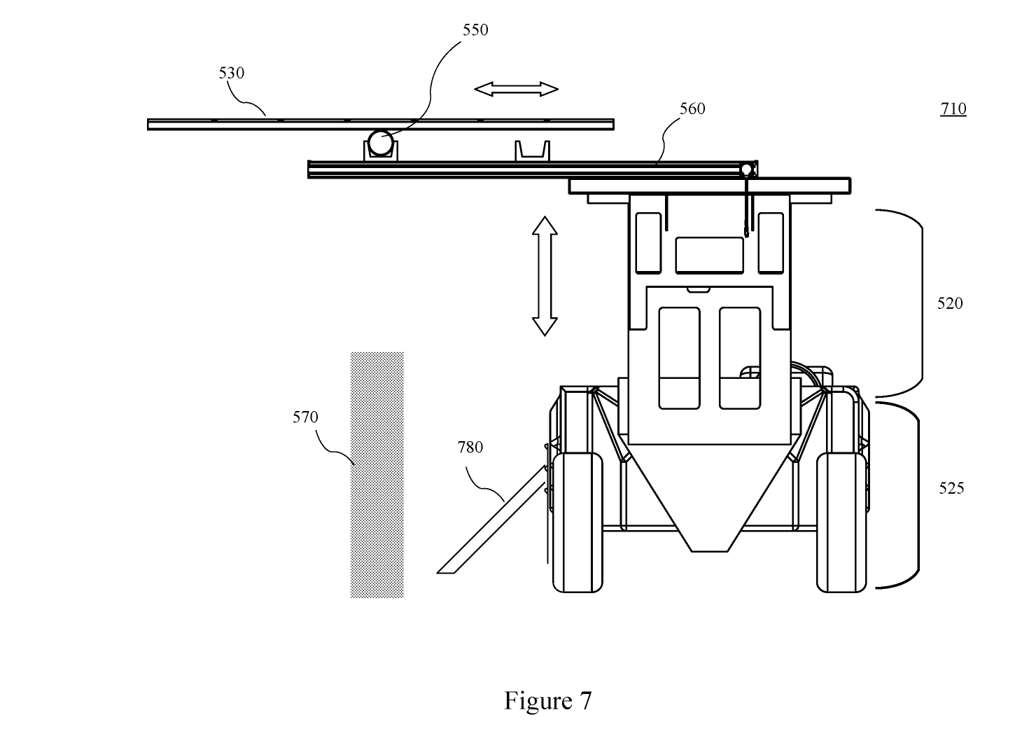

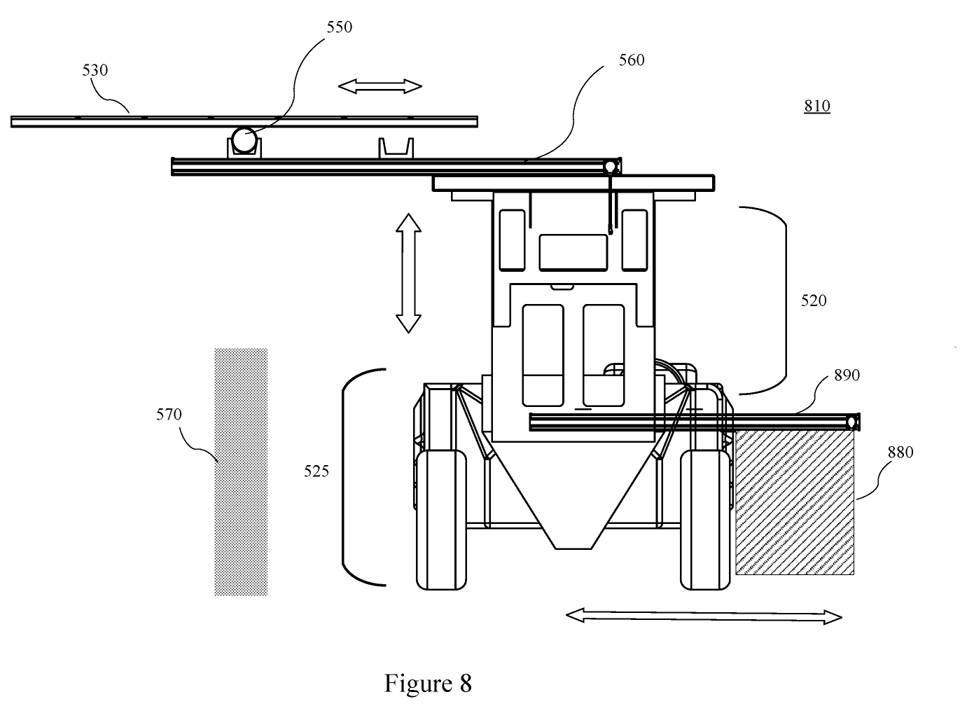

In certain instances, as a solar table mounted on a sideshift element is extended horizontally beyond the edge of the transport component, the mobile transport may become unstable due to the downward force applied at the end of the sideshift element. In order to correct this instability, certain embodiments of the mobile transport may have compensation elements that counter this destabilizing force. Two examples of compensation elements are illustrated in FIGS. 7 and 8.

FIG. 7 illustrates a mobile transport 710 that comprises at least one stabilizer that prevents tipping or unwanted movement of the mobile transport when a solar table is extended horizontally according to various embodiments of the invention. In this example, a stabilizer leg 780 extends horizontally and downward from the same side of the mobile transport relative to the horizontally extended solar table such that one side of the leg is positioned on the ground and the other side of the leg is positioned on the mobile transport 710. This stabilizer leg 780 reduces tipping on the mobile transport 710 as the solar table 530 is extended.

One skilled in the art will recognize that the shape and size of the stabilizer leg 780 may vary based on a variety of factors including the weight, size and shape of the mobile transport 710, the weight, size and shape of the solar table 530, the terrain in which the mobile transport is operating, and the distance of which the solar table 530 is extended. Other factors may also relate to the shape and size of the stabilizer leg 780. Additionally, multiple stabilizer legs may be employed on the mobile transport 710.

FIG. 8 illustrates a mobile transport with sideshift capability that includes a counterweight in accordance with various embodiments of the invention. In this example, a moveable counterweight 880 is provided that moves along a rail 890 so that the mobile transport 810 may be stable during horizontal extension of the solar table 530. As shown, the counterweight 880 is positioned on the opposite side of the extended solar table 530 to reduce tipping or movement of the mobile transport 810.

One skilled in the art will recognize that the size, weight and shape of the counterweight 880 may vary depending on a variety of parameters previously discussed. Furthermore, the manner in which the counterweight 880 moves may vary across different embodiments of the invention.

One skilled in the art will recognize that a solar table may have a variety of different support structures such as beams, purlins, etc., that either supplement or replace a torque tube. All of these different solar type examples are intended to fall within the scope of certain embodiments of the invention and the different ways in which the solar table is coupled to the mobile transport is intended to fall within the scope of certain embodiments of the invention..

One skilled in the art will recognize that the different movements supported by the mobile transport support robust alignment processes that allow for a more efficient and accurate alignment of a solar table to a corresponding mounting structure. In some embodiments, the alignment process(es) may be performed manually by personnel at the installation site that control each of the motors during alignment. In other embodiments, the alignment process(es) may be automatically performed by sensors and motor controls such that motor movement is controlled by computerized analysis of sensor data and/or image data. A variety of sensor technologies may be employed by a mobile transport such as LiDAR, camera sensors, radar sensors and other sensor technologies known to one of skill in the art. Furthermore, active and passive sensor systems may also be deployed.

In certain examples, detachable sensor systems may be positioned on a solar table (such as on a torque tube) prior to or during installation of the solar table. The detachable sensor device/system may be removed from the solar table once installation is complete and positioned on another table that needs to be installed within the system.

In other examples, the alignment process may comprise both manual and automated processes that result in the installation of a solar panel within the system.

The mobile transport may also include verification devices that confirm a solar table has been properly installed. These verification devices may include sensors that measure movement under a test force of the solar table to determine whether a swaged end is tightly inserted within a corresponding mounting structure.

It will be appreciated to those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

What is claimed is:

1. A mobile transport to facilitate solar system construction, the mobile transport comprising:
a transport component operable to move a solar table that comprises a torque tube and one or more solar modules attached to the torque tube; and
a first solar table alignment and support (STAS) component and a second STAS component coupled to the transport component, the first and second STAS components couple to the torque tube for solar table support and enable vertical and horizontal movements of the solar table.

2. The mobile transport of claim 1, wherein the first STAS component and the second STAS component are located on opposite ends of the transport component.

3. The mobile transport of claim 1, wherein the first STAS component and the second STAS component are operated independently or jointly to enable pitch and yaw control of the torque tube besides the horizontal and vertical movements for a dynamic alignment process of the torque tube.

4. The mobile transport of claim 1, wherein each STAS component comprises:
at least one first solar table securing clamp that couples to the torque tube; and
a sideshift element to move the torque tube horizontally during an alignment process.

5. The mobile transport of claim 4, wherein the sideshift element comprises a rail on which the torque tube moves horizontally during an alignment process.

6. The mobile transport of claim 5, wherein the rail is positioned proximate to a top end of each STAS component.

7. The mobile transport of claim 5, wherein the rail is positioned proximate to a bottom end of each STAS component.

8. The mobile transport of claim 4, wherein the at least one first solar table securing clamp comprises at least one end effector that securely holds the torque tube to allow movement and alignment.

9. The mobile transport of claim 1 further comprising:
a counterweight that is positioned on an opposite side of a sideshift direction of the solar table to stabilize the mobile transport during horizontal movement of the solar table.

10. The mobile transport of claim 9 further comprising:
a rail on which the counterweight is moved to a balance position.

11. The mobile transport of claim 1 further comprising:
at least one stabilizer leg that stabilizes the mobile transport during horizontal motion of the solar table.

12. The mobile transport of claim 11, wherein the at least one stabilizer leg extends horizontally and downward from the same side of the mobile transport relative to a sideshift direction of the solar table .

13. The mobile transport of claim 1, wherein each STAS component comprises multiple motors to enable horizontal and vertical movements of the solar table.

14. A method of solar table installation at an installation site, the method comprising:
operating a transport component of a mobile transport to move a solar table toward a point of installation for the solar table, the solar table comprises a torque tube and one or more solar modules attached to the torque tube, the torque tube is supported by a first solar table alignment and support (STAS) component and a second STAS component of the mobile transport;
approaching the mobile transport to the point of installation in preparation for installation of the solar table; and
aligning the torque tube at the installation point for installtion of the solar table, the alignment comprises vertical and horizontal movements of the torque tube enabled by the first and second STAS components.

15. The method of claim 14, wherein the alignment further comprises pitch and yaw control of the torque tube.

16. The method of claim 15, wherein the pitch and yaw control is enabled by independently and/or jointly operation of the first STAS component and the second STAS component.

17. The method of claim 14, wherein each STAS component comprises:
at least one first solar table securing clamp that couples to the torque tube; and
a sideshift element to move the torque tube horizontally during the alignment.

18. The method of claim 17, wherein the sideshift element comprises a rail on which the torque tube moves horizontally during an alignment process.

19. The method of claim 18, wherein the rail is positioned proximate to a top or bottom end of each STAS component.

20. The method of claim 14 further comprising:
attaching the solar table to supporting piles that lock the solar table in line with adjacent solar tables; and
detaching the solar table from the mobile transport.
